(19) United States
(12) Patent Application Publication
(10) Pub. No.: US 2025/0298501 A1
(43) Pub. Date: Sep. 25, 2025

(54) DISPLAY DEVICE, IMAGE FORMING APPARATUS, AND DISPLAY CONTROL METHOD FOR ADDITIONAL DISPLAY

(71) Applicant: SHARP KABUSHIKI KAISHA, Osaka (JP)

(72) Inventor: MAYUKO YOSHIDA, Osaka (JP)

(21) Appl. No.: 19/060,959

(22) Filed: Feb. 24, 2025

(30) Foreign Application Priority Data
Mar. 19, 2024 (JP) 2024-042952

(51) Int. Cl. G06F 3/04845; G06F 3/04855

(52) U.S. Cl. CPC G06F 3/04845; G06F 3/04855

(57) ABSTRACT

A display device includes: a display that displays an operation screen including an object; and a controller that controls display of an additional display corresponding to the object, based on a user operation on the object, wherein the controller changes a display mode of the additional display in accordance with a positional relationship between an arrangement position of the object on the operation screen and a position of the user operation on the object.

### CROSS-REFERENCE TO RELATED APPLICATION

The present application claims priority from Japanese Application JP2024-042952, the content of which is hereby incorporated by reference into this application.

### BACKGROUND OF THE INVENTION

### 1. Field of the Invention

The present disclosure relates to a display device, an image forming apparatus, and a display control method for an additional display.

### 2. Description of the Related Art

There is known a technique for displaying, on a screen, information (supplementary information) about an object such as a button or an icon on an operation screen of a display device as an additional display when the object is hovered over or long-pressed with a mouse.

For example, a related art discloses that when a tooltip showing information about a target item (object) selected by a user is displayed as an additional display, if the display of the tooltip covers the target item, a display position of the target item is adjusted so that the display of the tooltip does not cover the target item.

### SUMMARY OF THE INVENTION

In one aspect of the present disclosure, an object of the present disclosure is to provide a display device and the like capable of improving a visibility and a readability of a display item displayed in an additional display, as a result of which it is possible to improve user convenience.

To solve the above problem, a display device according to one aspect of the present disclosure includes a display that displays an operation screen including an object, and a controller that controls display of an additional display corresponding to the object, based on a user operation on the object, and the controller changes a display mode of the additional display depending on a positional relationship between an arrangement relationship of the object on the operation screen and a position of the user operation on the object.

An image forming apparatus according to one aspect of the present disclosure includes a display that displays an operation screen including an object, a controller that controls display of an additional display corresponding to the object, based on a user operation on the object, and an image former, and the controller changes a display mode of the additional display depending on a positional relationship between an arrangement position of the object on the operation screen and a position of the user operation on the object.

A display control method for an additional display according to one aspect of the present disclosure includes displaying an operation screen including an object, controlling display of an additional display corresponding to the object, based on a user operation on the object, and changing a display mode of the additional display according to a positional relationship between an arrangement position of the object on the operation screen and a position of the user operation on the object.

According to one aspect of the present disclosure, it is possible to provide a display device and the like capable of improving a visibility and a readability of a display item displayed in an additional display, as a result of which it is possible to improve user convenience.

### BRIEF DESCRIPTION OF THE DRAWINGS

FIG. 1 is a diagram illustrating an overall configuration of an image forming apparatus according to a first embodiment.

FIGS. 2A and 2B are diagrams illustrating a functional configuration of the image forming apparatus incorporating a display device according to the first embodiment.

FIG. 3 is a flowchart illustrating a process flow according to the first embodiment.

FIGS. 4A to 4F are diagrams illustrating an example of an operation according to the first embodiment.

FIG. 5 is a diagram illustrating an example of an operation according to the first embodiment.

FIG. 6 is a diagram illustrating an example of an operation according to the first embodiment.

FIG. 7 is a diagram illustrating an example of an operation according to the first embodiment.

FIG. 8 is a flowchart illustrating a process flow according to a second embodiment.

FIG. 9 is a diagram illustrating an example of an operation according to the second embodiment.

FIG. 10 is a flowchart illustrating a process flow according to a third embodiment.

FIGS. 11A and 11B are diagrams illustrating an example of an operation according to the third embodiment.

FIG. 12 is a flowchart illustrating a process flow according to a fourth embodiment.

FIG. 13 is a diagram illustrating an example of an operation according to the fourth embodiment.

FIG. 14 is a flowchart illustrating a process flow according to a fifth embodiment.

FIGS. 15A and 15B are diagrams illustrating an example of an operation according to the fifth embodiment.

FIG. 16 is a flowchart illustrating a process flow according to a sixth embodiment.

FIGS. 17A and 17B are diagrams illustrating an example of an operation according to the sixth embodiment.

### DETAILED DESCRIPTION OF THE INVENTION

Embodiments of the present disclosure will be described below with reference to the drawings. Note that the following embodiments are an example for explaining the present disclosure, and the technical content of the description described in the claims is not limited to the following description.

There is known a technique for displaying information (supplementary information) about an object displayed on an operation screen of a display device as an additional display when the object is selected by a user operation (for example, a long-press on the object).

The additional display is known in a display mode such as a tooltip and a balloon. The additional display may be displayed in the form of a rectangle or a word balloon. The additional display may be displayed in the form of a pop-up. In the following, a rectangular tooltip will be described for one form of the additional display.

A tooltip being one form of the additional display displays information (supplementary information) about an object within a rectangular display area. If the operation screen of the display device is small, for example, about 4 inches, and there are a plurality of pieces of information to be displayed, even if a tooltip is used, it may be difficult to display all information which a user wants to check.

In the present disclosure, the following embodiments realize a display device and the like capable of improving a visibility and a readability of a display item displayed in an additional display such as a tooltip, as a result of which it is possible to improve user convenience.

### 1 First Embodiment

### 1.1 Functional Configuration

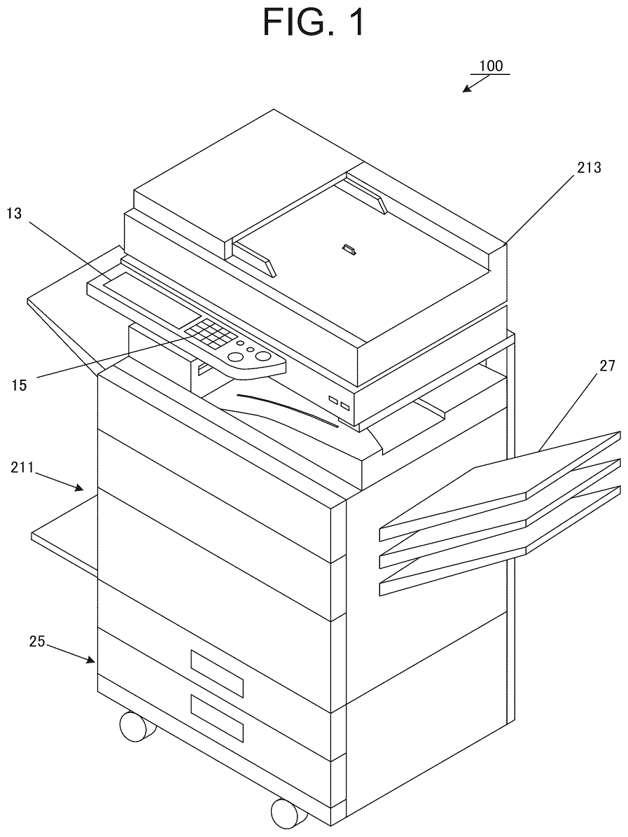

FIG. 1 is a diagram illustrating an overall configuration of an image forming apparatus 100 incorporating a display device 103 according to a first embodiment. In the first embodiment, an aspect of a multifunction peripheral will be described for an example of the image forming apparatus 100 incorporating the display device 103. However, the image forming apparatus 100 is not particularly limited as long as the image forming apparatus 100 is configured to incorporate the display device 103 according to the first embodiment, and may be, for example, a printer, a copier, or a fax machine, with limited types of job functions.

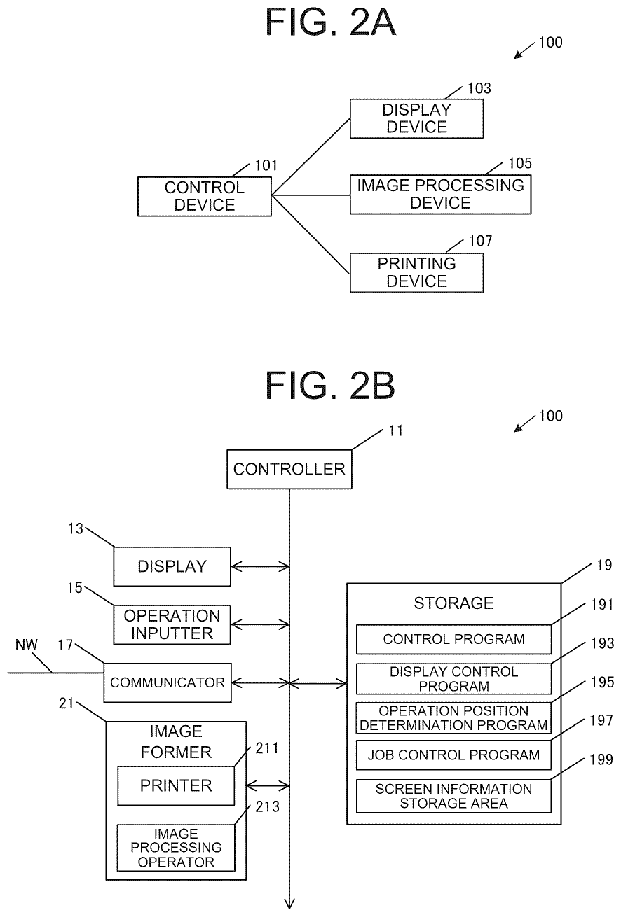

FIG. 2A is a diagram illustrating a configuration of the image forming apparatus 100. The image forming apparatus 100 includes a control device 101, the display device 103, an image processing device 105, and a printing device 107. The devices illustrated in FIG. 2A may be formed as a single unit, or a plurality of the devices may be combined to form a unit. For example, the image processing device 105 and the printing device 107 may be a single device.

FIG. 2B is a diagram illustrating a functional configuration of the image forming apparatus 100. Each of the devices illustrated in FIG. 2A may have a function illustrated in FIG. 2B, as necessary.

The image forming apparatus 100 includes, as its functional configuration, a controller 11, a display 13, an operation inputter 15, a communicator 17, a storage 19, and an image former 21.

The controller 11 controls the entire image forming apparatus 100. The controller 11 can include one or more processing devices (for example, a central processing operator (CPU) and a System on Chip (SoC)). The controller 11 realizes the functions by reading and executing various types of programs stored in the storage 19.

The display 13 displays various types of information to a user. The display 13 can include, for example, a liquid crystal display (LCD), or an organic electro-luminescence (EL) display. The display 13 displays an operation screen (for example, a home screen, a setting screen for executing each job, or a history information screen) according to a state of the image forming apparatus 100. The display 13 according to the present disclosure has a display area of, for example, about 4 inches, which is a relatively small display size compared to that having a display area of about 10 inches. An operation screen of the display 13 described below has a system area, which will be described later, and a selection area where selectable items are scrolled for display, and is described as an operation screen having a screen configuration in which the number of selectable items in a selectable area (on one screen) is five or less.

The operation inputter 15 accepts information input by a user or the like. The operation inputter 15 can include various types of input device including an operation key such as a hard key and a software key, and a button. The operation inputter 15 may also be configured as a touch panel to accept an input via the display 13. When the operation inputter 15 is configured as a touch panel, the operation inputter 15 can sense a touch operation, a tap operation, a swipe operation, and the like by a user on an object displayed via the display 13, and obtain coordinate information, pressure sensitivity information, and the like on the touch panel. The obtained coordinate information, pressure sensitivity information, and the like can be used to determine a position and a time of a user operation on an object. An example of an input method for the touch panel includes a common method including a resistive film method, an infrared method, an electromagnetic induction method, or a capacitive method.

The communicator 17 has either wired or wireless interface or the both for communicating with other external terminal devices (not illustrated) via a network NW such as a local area network (LAN), a wide area network (WAN), the Internet, a telephone line, and a FAX line. The communicator 17 may include an interface for (short-range) wireless communication technologies such as Bluetooth (registered trademark), Near Field Communication (NFC), Wi-Fi (registered trademark), ZigBee (registered trademark), Infrared Data Association (IrDA), and a wireless Universal Serial Bus (USB).

The storage 19 is one or more storage devices that store various types of programs and various types of data required for an operation of the image forming apparatus 100. The storage 19 can include a storage device such as a random access memory (RAM), a solid state drive (SSD), a hard disk drive (HDD), or a read only memory (ROM).

In the first embodiment, the storage 19 stores a control program 191, a display control program 193, an operation position determination program 195, and a job control program 197, and reserves a screen information storage area 199.

The control program 191 is a program read by the controller 11 when the controller 11 totally controls the display device 103 and the image forming apparatus 100. The controller 11 that reads the control program 191 controls driving of hardware such as the display 13, the operation inputter 15, the communicator 17, and the image former 21.

The display control program 193 is a program read by the controller 11 in controlling an output of the operation screen displayed on the display 13 or the operation inputter 15 configured as a touch panel. The controller 11 that reads the display control program 193 controls an arrangement position of an object on the operation screen, based on the screen information regarding the object stored in the screen information storage area 199, as a result of which an operation screen such as a home screen, a setting screen for the execution of each job, and a history information screen is formed. The controller 11 that reads the display control program 193 changes a display mode of the additional display according to the arrangement position of the object on the operation screen and a position of a user operation (the position of a finger of a user) relative to the object determined based on the operation position determination program 195.

The operation position determination program 195 is a program read by the controller 11 in determining a position of a user operation relative to an object on the operation screen. After reading the operation position determination program 195, the controller 11 determines a position and a time of an operation on an object from coordinate information and pressure sensitivity information based on a user operation such as touch operation and a drag operation obtained from the operation inputter 15 configured as a touch panel.

The job control program 197 is a program read by the controller 11 in executing a print job for printing, copying, and the like, or a job for FAX or image transmission. The controller 11 that reads the job control program 197 transitions to a job mode (a print mode, a copy mode, a FAX mode, an image transmission mode, and the like) for executing a job in each job, and executes the job. In executing a job, the controller 11 can display an operation screen for accepting a setting value and a function selection required for executing the job from a user as necessary. The controller 11 executes a job, based on the setting value and the function accepted via the operation screen.

The screen information storage area 199 is a storage area for storing screen information about an object, layout information for arranging an object to form an operation screen, and the like. The screen information storage area 199 includes, in addition to screen information about an object, screen information about a tooltip as an additional display for displaying information (supplementary information) about the object.

The image former 21 includes a printer 211 and an image processing operator 213. The printer 211 feeds a sheet from a sheet feeder 25, forms an image based on image data on the sheet, and then discharges the sheet to a sheet discharger 27. The printer 211 can include, for example, a laser printer employing an electrophotographic method. In such a case, the printer 211 forms an image using a toner supplied from a toner cartridge (not illustrated) corresponding to a toner color (for example, cyan, magenta, yellow, or black).

The image processing operator 213 generates image data by scanning an original. The image processing operator 213 can be configured as a scanner device including, for example, an image sensor such as a charge coupled device (CCD) or a contact image sensor (CIS), as well as an automatic document feeder (ADF) and a flatbed for placing and reading an original. There are no particular limitations on the configuration of the image processing operator 213 as long as the image processing operator 213 is capable of generating image data by reading a reflected light image from an original image with an image sensor. The image processing operator 213 can also be configured as an interface capable of obtaining image data stored in a storage medium such as a USB memory or image data transmitted from an external terminal device (not illustrated). The image processing operator 213 may be configured to correct, for example, shading or density on image data input from a scanner device to generate image data for image transmission.

The functions described above may be provided redundantly if each of the control device 101, the display device 103, the image processing device 105, and the printing device 107 realizes the function individually. For example, the display device 103, the image processing device 105, and the printing device 107 may each have the controller 11, the storage 19, and the like. Each device may share the controller 11, the storage 19, and the like.

### 1.2 Process Flow

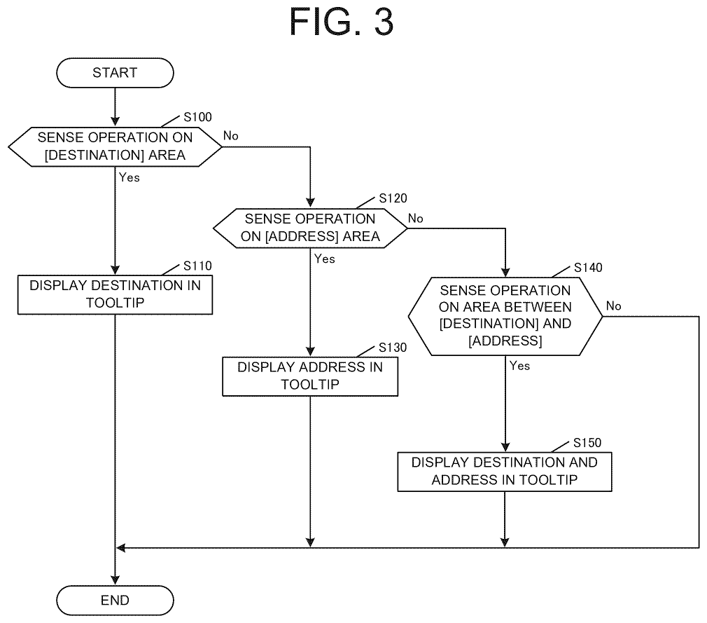

Next, a process flow according to the first embodiment will be described. FIG. 3 is a flowchart illustrating an example of a process for changing a display item in a tooltip as an additional display according to a positional relationship between an arrangement position of an object on the operation screen and a position of a user operation relative to the object.

The process described with reference to FIG. 3 is executed by the controller 11 reading out the display control program 193, the operation position determination program 195, and the like. In FIG. 3, it is assumed that a transmission history including an object having a [Destination] area in which a destination to which data is transmitted is displayed as a caption and an [Address] area in which address information of a destination to which data is transmitted is displayed as a caption is displayed on the operation screen.

The controller 11 determines whether a user operation is sensed in the[Destination] area of an object displayed on the operation screen (step S100). If the controller 11 determines that a user operation in the[Destination] area is sensed, the controller 11 displays a tooltip with a character string representing the[Destination] as a display item, and the process ends (step S100; if Yes, the process proceeds to step S110, and the process proceeds to “End”).

On the other hand, if the controller 11 determines that a user operation in the[Destination] area is not sensed, the controller 11 determines whether a user operation is sensed in the[Address] area of the object (step S100; if No, the process proceeds to step S120).

If the controller 11 determines that a user operation in the[Address] area is sensed, the controller 11 displays a tooltip with a character string representing the[Address] as a display item, and the process ends (step S120; if Yes, the process proceeds to step S130, and the process proceeds to “End”).

If the controller 11 determines that a user operation in the[Address] area is not sensed, the controller 11 determines whether a user operation is sensed in an area between the[Destination] area and the[Address] area of the object (step S120; if No, the process proceeds to step S140).

If the controller 11 determines that a user operation is sensed in an area between the[Destination] area and the[Address] area, the controller 11 displays a tooltip with a character string representing the[Destination] and the[Address] as a display item, and the process ends (step S140; if Yes, the process proceeds to step S150, and the process proceeds to “End”).

On the other hand, if the controller 11 determines that a user operation is not sensed in an area between the[Destination] area and the[Address] area, the process ends (step S140; if No, the process proceeds to “End”).

1.3 Example of Operation

Prior to describing an example of an operation according to the first embodiment, an example of the display size and the number of lines of a character string of a tooltip that can be displayed in the image forming apparatus 100 (displayed device 103) according to the present disclosure will be described.

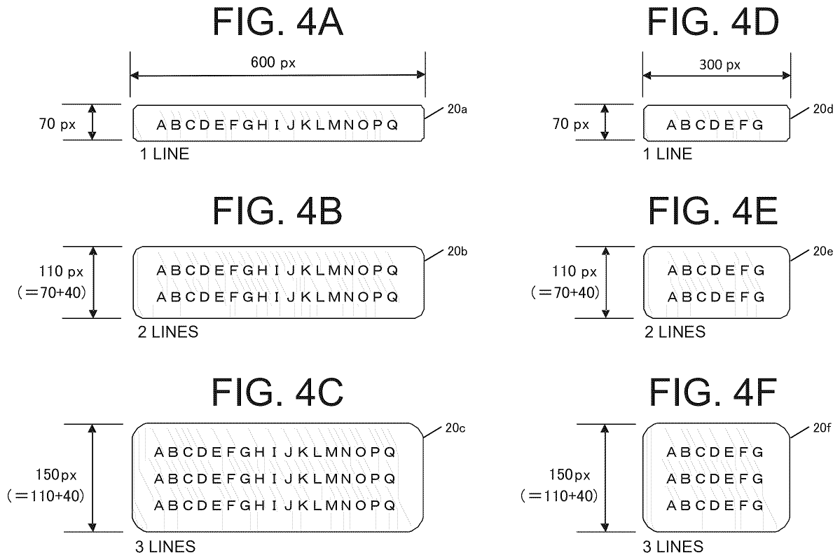

FIG. 4A is a diagram illustrating a tooltip 20a having a display size of 600 px in width×70 px in height. The tooltip 20a is an example of a tooltip capable of displaying a character string for one line of 17 full-width characters.

FIG. 4B is a diagram illustrating a tooltip 20b having a display size of 600 px in width×110 px in height (70 px+40 px). The tooltip 20b is an example of a tooltip capable of displaying character strings for two lines, each of which is 17 full-width characters.

FIG. 4C is a diagram illustrating a tooltip 20c having a display size of 600 px in width×150 px in height (110 px+40 px). The tooltip 20c is an example of a tooltip capable of displaying character strings for three lines, each of which is 17 full-width characters.

FIG. 4D is a diagram illustrating a tooltip 20d having a display size of 300 px in width×70 px in height. The tooltip 20d is an example of a tooltip capable of displaying a character string for one line of seven full-width characters.

FIG. 4E is a diagram illustrating a tooltip 20e having a display size of 300 px in width×110 px in height (70 px+40 px). The tooltip 20e is an example of a tooltip capable of displaying character strings for two lines, each of which is seven full-width characters.

FIG. 4F is a diagram illustrating a tooltip 20f having a display size of 300 px in width×150 px in height (110 px+40 px). The tooltip 20f is an example of a tooltip capable of displaying character strings for three lines, each of which is seven full-width characters.

For example, in displaying a tooltip including character strings representing the[Destination] and the[Address] in step S150 and the like of the flowchart in FIG. 3, to make both the character string representing the[Destination] and the character string representing the[Address] easily visible (readable), the number of lines of character strings displayed in the tooltip 20 is changed to two lines, and the character string representing the[Destination] and the character string representing the[Address] are displayed in each line. In such a case, “changing the number of lines to two lines” means changing the display size of the display area of the tooltip by switching the display of the tooltip 20 from the tooltip 20a or 20d (displayed in one line) illustrated in FIG. 4 to the tooltip 20b or 20e (displayed in the two lines). To change the number of lines to three lines, the display of the tooltip 20 may be switched from the tooltip 20a or 20d (displayed in one line) illustrated in FIG. 4 to the tooltip 20c or 20f (displayed in three lines).

In the following description, if there is no need to distinguish between the tooltips (20a to 20f) illustrated in FIG. 4, the tooltips will simply be referred to as tooltip 20.

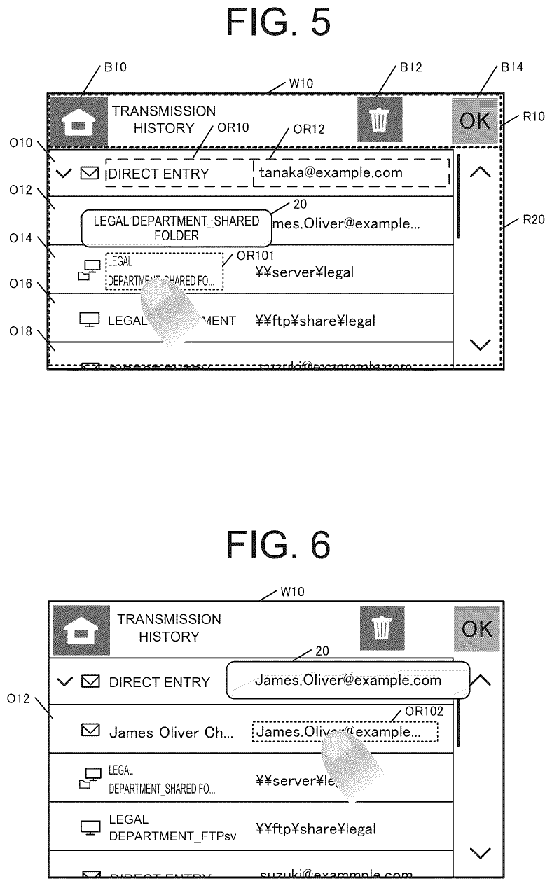

FIG. 5 is a diagram illustrating an example of the display configuration of an operation screen W10 according to a transmission history. The operation screen W10 according to a transmission history is an operation screen on which a transmission history for transmission jobs such as FAX or image transmission is displayed, and can be called up, for example, from a home screen (not illustrated) or an operation screen for execution of each FAX or image transmission job.

Such an operation screen W10 includes a system area R10 and a selection area R20 for scroll-displaying selectable items. The system area R10 is provided, for example, in the header portion of the operation screen W10, and includes operation buttons including a home button B10 that accepts screen transition to a home screen (not illustrated), a trash button B12 that accepts an instruction to delete an object, and an OK button B14 that accepts an instruction to end display of the operation screen W10 by reflecting various types of settings, changes, and the like. The system area R10 can have a display configuration common to other operation screens (not illustrated) except for a display area (for example, “transmission history”) indicating which operation screen the operation screen W10 is.

The selection area R20 is provided in a body portion below the system area R10, and in the first embodiment, is configured so that five (or less) objects (objects O10 to O18) can be selected as items. For example, if any of the objects O10 to O18 is selected and an instruction for selecting the OK button B14 is accepted, the controller 11 transitions to an operation screen for a transmission job to which the[Destination] and the[Address] corresponding to the selected object are applied. The user can transmit a fax or an image to the[Address] specified by the selected [Destination].

Each object (for example, the object O10) includes a [Destination] area OR10 and an [Address] area OR12 that can be operated by the user. The [Destination] area OR10 is a display area for displaying the[Destination] in a transmission job such as FAX or image transmission. The [Address] area OR12 is a display area for displaying address information (such as an e-mail address or path information about the storage destination of image data) specified by the destination in a transmission job such as FAX or image transmission.

Here, if in the[Destination] area OR10 and the[Address] area OR12, a character string of a caption cannot be displayed due to the limitations of a display frame of the areas and an ellipsis symbol “ . . . ” is displayed indicating that a part of the character string is omitted, an instruction to display a tooltip where the omitted part is displayed as supplementary information can be accepted.

For example, if the[Destination] area OR101 of the object O14 is operated (pointed out) by the user, the controller 11 displays, in the tooltip 20, “Legal department_shared folder” as supplementary information to “Legal department_shared fo . . . ”, which supplements the omitted” . . . ” part.

Similarly, FIG. 6 illustrates an example of a display configuration of a tooltip displayed by the controller 11 when the[Address] area OR102 of the object O12 is operated (pointed out) by the user. In such a case, the controller 11 displays, in the tooltip 20, “James.Oliver@example.com” which supplements the omitted “ . . . ” part as supplementary information to “James.Oliver@example . . . ”.

FIGS. 5 and 6 illustrate an example in which the tooltip 20 with different display items is individually displayed if a user operates either the[Destination] area (for example, the[Destination] area OR101) or the[Address] area (for example, the[Address] area R102). On the other hand, for example, depending on the position of the user operation, it is also possible to change the display mode of the tooltip 20 from the tooltip 20a (20d) capable of displaying one line of character string as illustrated in FIG. 4 to the tooltip 20b (20e) capable of displaying two lines of character strings, and display two lines of character strings displayed in the tooltip 20.

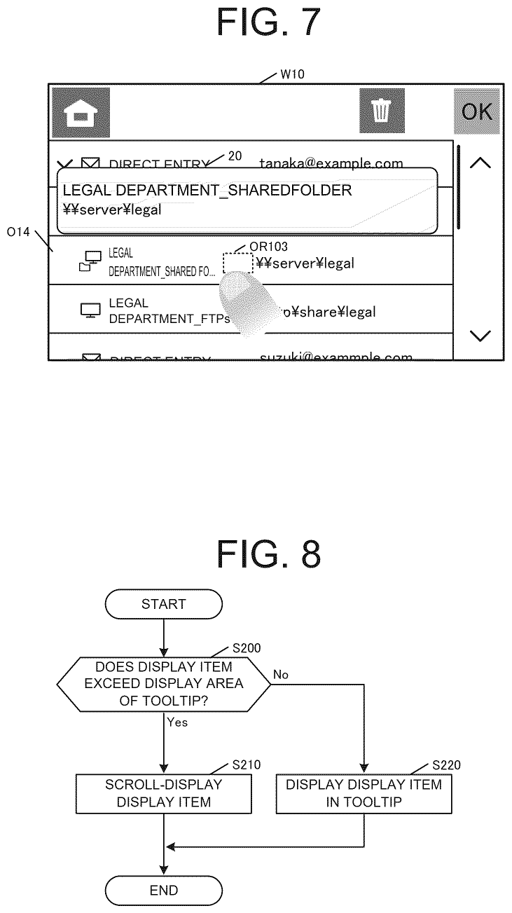

FIG. 7 illustrates an example of a display configuration of the tooltip 20 displayed by the controller 11 if an area OR103 between the[Destination] area and the[Address] area of the object O14 is operated (pointed out) by the user. In such a case, the controller 11 displays the character string representing the[Destination] and the character string representing the[Address] on each line (“Legal department_shared folder ¥¥server¥legal”) to make both the character string representing the[Destination] and the character string representing the[Address] easily visible. In such a case, it is sufficient that the caption displayed in either the[Destination] area or the[Address] area has a part of character strings omitted, and a part of the character strings in both the[Destination] area and the[Address] area may not be omitted.

The tooltip 20 illustrated in FIG. 5 to FIG. 7 can be displayed in either display form depending on the position of the user operation. For example, if the user operates an area near either the[Destination] area or the[Address] area, the controller 11 displays the tooltip 20 corresponding to the[Destination] area or the[Address] area individually, and if the user operates an area near the area between the[Destination] area and the[Address] area, the controller 11 may also display the tooltip 20 corresponding to the[Destination] area and the[Address] area.

As the user moves the operation position (for example, from left to right in FIG. 7), the display of the tooltip 20 corresponding to the[Destination] area, the display of the tooltip 20 corresponding to the area between the[Destination] area and the[Address] area, and the display of the tooltip 20 corresponding to the[Address] area may be switched sequentially.

As described above, according to the first embodiment, it is possible to change a display item of a tooltip as an additional display depending on a positional relationship between an arrangement position of an object on an operation screen and a position of a user operation relative to the object, as a result of which it is possible to improve a visibility and a readability of the display item displayed in the tooltip.

### 2 Second Embodiment

A second embodiment is an aspect in which if the display item displayed in the tooltip 20 exceeds the display size of the display area of the tooltip 20, character strings as a display item are scrolled to display all the character strings.

The functional configuration of the image forming apparatus 100 incorporating the display device 103 according to the second embodiment can be similar to that according to the first embodiment, and therefore a description thereof will be omitted here.

### 2.1 Process Flow

A process flow according to the second embodiment will be described. FIG. 8 is a flowchart illustrating a process for scrolling character strings as a display item to display all the character strings if the display item displayed in the tooltip 20 exceeds the display size of the display area of the tooltip 20. The process described with reference to FIG. 8 is executed by the controller 11 reading out the display control program 193, the operation position determination program 195, and the like. The process described in FIG. 8 is based on the process described in the flowchart of FIG. 3 and will be described assuming that the tooltip 20 is displayed in which the display item is a character string representing[Destination], [Address], or both[Destination] and[Address].

The controller 11 determines whether the display item displayed in the tooltip 20 displayed on the operation screen exceeds the display size of the display area of the tooltip 20 (step S200).

If the controller 11 determines that if the display item displayed in the tooltip 20 exceeds the display size of the display area of the tooltip 20, the controller 11 scrolls character strings as the display item to display all the character strings and the process ends (step S200; if Yes, the process proceeds to step S210, and the process proceeds to “End”).

On the other hand, if the controller 11 determines that the display item displayed in the tooltip 20 does not exceed the display size of the display area of the tooltip 20, the controller 11 displays a character string as the display item and the process ends (step S200; if No, the process proceeds to step S220, and the process proceeds to “End”).

### 2.2 Example of Operation

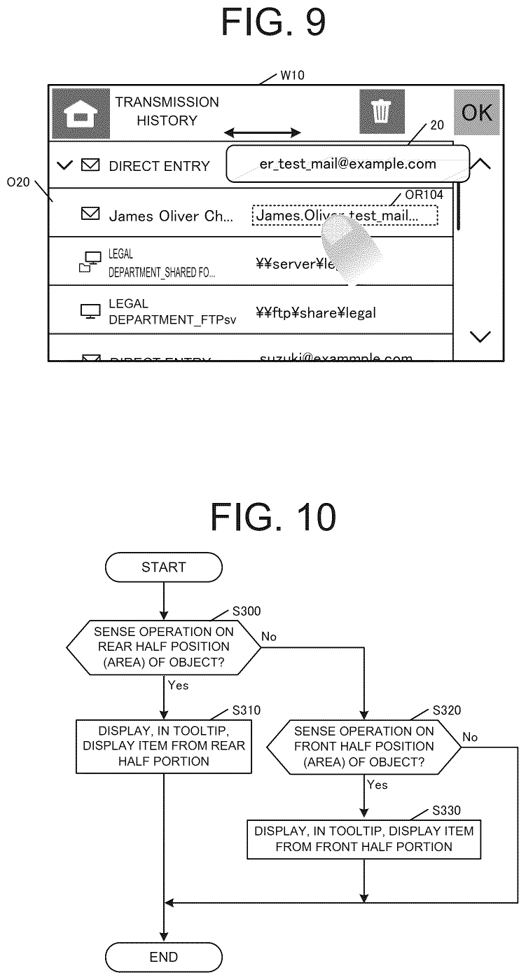

FIG. 9 illustrates an example of a display configuration of the tooltip 20 displayed by the controller 11 if the[Address] area OR104 of an object O20 is operated (pointed out) by the user. If the controller 11 determines that the display item displayed in the tooltip 20 exceeds the display size of the display area of the tooltip 20, the controller 11 displays the tooltip 20 where all the character strings “James.Oliver_test_mail@example.com” can be displayed by scrolling the character strings for “James.Oliver_test_mail . . . ” in either direction of the arrows in the figure.

As described above, according to the second embodiment, in addition to the effects of the first embodiment, if the display item displayed in a tooltip exceeds the display size of the display area of the tooltip, character strings as the display item can be scrolled to display all the character strings, so that the user can also check a character string not displayed as a display item.

### 3 Third Embodiment

A third embodiment is an aspect in which if a display item displayed in the tooltip 20 exceeds the display size of the display area of the tooltip 20, the display position of a character string as a display item is changed.

The functional configuration of the image forming apparatus 100 incorporating the display device 103 according to the third embodiment can be similar to that according to the first embodiment, and therefore description thereof will be omitted here.

### 3.1 Process Flow

A process flow according to the third embodiment will be described. FIG. 10 is a flowchart illustrating a process for changing the display position of a character string as a display item if the display item displayed in the tooltip 20 exceeds the display size of the display area of the tooltip 20. The process described with reference to FIG. 10 is executed by the controller 11 reading out the display control program 193, the operation position determination program 195, and the like.

The controller 11 determines whether a user operation is sensed in a rear half position (area) of an object displayed on the operation screen (step S300). Here, the rear half position of the object may be the rear half portion of the area obtained by simply dividing, into two, the area from the display start position of the character string to the display end position of the character string in each of the[Destination] area or the[Address] area of the object, or may be the rear half position (area) of the object, based on the number of the (displayable) character string including the ellipsis character “ . . . ”.

If the controller 11 determines that a user operation is sensed in the rear half position (area) of the object, the controller 11 displays the character string in the rear half portion of the display item representing the[Destination] or the[Address] as a tooltip and the process ends (step S300; if Yes, the process proceeds to step S310, and the process proceeds to “End”).

On the other hand, if the controller 11 determines that no user operation is sensed in the rear half position (area) of the object, the controller 11 determines whether a user operation is sensed in the front half position (area) of the object (step S300; if No, the process proceeds to step S320). If the controller 11 determines that a user operation is sensed in the front half position (area) of the object, the controller 11 displays the character string in the front half portion of the display item representing the[Destination] or the[Address] in a tooltip and the process ends (step S320; if Yes, the process proceeds to step S330, and the process proceeds to “End”).

On the other hand, if the controller 11 determines that no user operation is sensed in the front half position (area) of the object, the process ends (step S320; if No, and the process proceeds to “End”).

### 3.2 Example of Operation

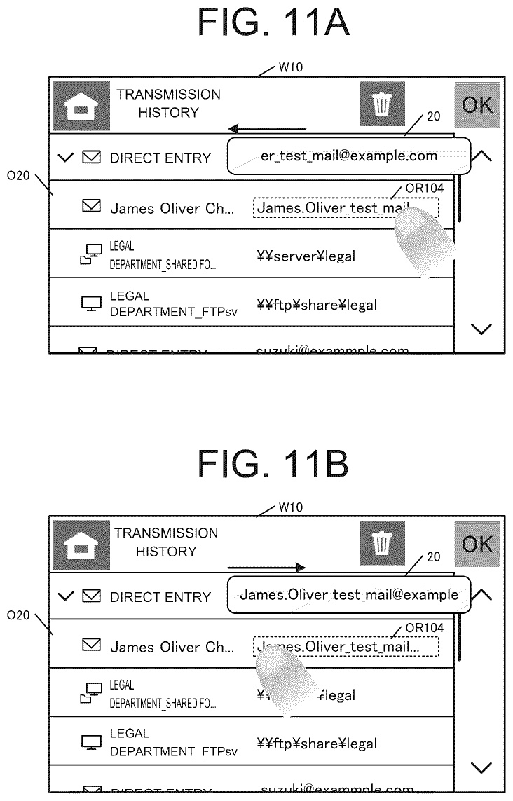

FIG. 11A illustrates an example of a display configuration of the tooltip 20 displayed by the controller 11 if a user operates (points out) on a rear half position (area) of the[Address] area OR104 of the object O20 (“James.Oliver_test_mail . . . ”). If the controller 11 senses a user operation on the rear half position (area) of the[Address] area OR104, the controller 11 displays the rear half portion of the display item representing the[Address] (“er_test_mail@example.com”) in the tooltip 20 in the direction of the arrow in the figure (to the left).

On the other hand, FIG. 11B illustrates an example of a display configuration of the tooltip 20 displayed by the controller 11 if a user operates on (points out) a front half position (area) of the[Address] area OR104 of the object O20 (“James.Oliver_test_mail . . . ”). The controller 11 displays the front half position of the display item representing the[Address] (“James.Oliver_test_mail@example”) in the tooltip 20 in the direction of the arrow in the figure (to the right).

As described above, according to the third embodiment, in addition to the effects of the first embodiment, if a display item displayed in a tooltip exceeds the display size of a display area of the tooltip, a display position of a character string as the display item displayed in the tooltip can be changed according to a position of a user operation, as a result of which it possible to determine the character string displayed in the tooltip according to a display position of an object that a user wishes to display to further improve convenience.

### 4 Fourth Embodiment

A fourth embodiment is an aspect in which if a display item displayed in the tooltip 20 exceeds the display size of the display area of the tooltip 20, a display start position of a character string is changed according to a type of a caption displayed in an object.

The functional configuration of the image forming apparatus 100 incorporating the display device 103 according to the fourth embodiment can be similar to that according to the first embodiment, and therefore description thereof will be omitted here.

### 4.1 Process Flow

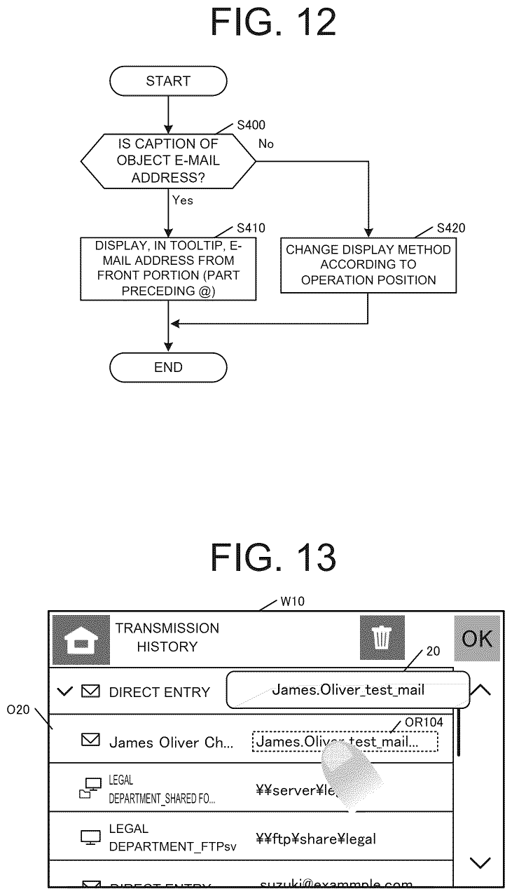

A process flow according to the fourth embodiment will be described. FIG. 12 is a flowchart illustrating a process for changing a display start position of a character string according to a type of a caption displayed in an object if a display item displayed in the tooltip 20 exceeds the display size of the display area of the tooltip 20. The process described with reference to FIG. 12 is executed by the controller 11 reading out the display control program 193, the operation position determination program 195, and the like. In FIG. 12, an example of a character string for an e-mail address will be described for a type of a caption displayed in an object.

The controller 11 determines whether the type of the caption of the object displayed on the operation screen is a character string for an e-mail address (step S400).

If the controller 11 determines that the type of the caption of the object is a character string for an e-mail address, the controller 11 displays the character string included in the front portion of the e-mail address (a part preceding @) in a tooltip, and the process ends (step S400; if Yes, the process proceeds to step S410, and the process proceeds to “End”). Typically, the components (character string) following “@” included in an e-mail address are often in a standard format, so there is little need to display the character string following “@” in the tooltip 20. Therefore, in the fourth embodiment, if the type of the caption of the object is a character string for an e-mail address, the display of the components following “@” is omitted, and the character string included in the front portion of the e-mail address (a part preceding @) is displayed in the tooltip 20.

If the controller 11 determines that the type of the caption of the object is not a character string for an e-mail address, the controller 11 changes the display method according to the operation position and the process ends (step S400; if No, the process proceeds to step S420, and the process proceeds to “End”).

### 4.2 Example of Operation

FIG. 13 illustrates an example of a display configuration of the tooltip 20 displayed by the controller 11 if a user operates (points out) the[Address] area OR104 of the object O20 (“James.Oliver_test_mail . . . ”). If the controller 11 determines that a type of a caption displayed in the[Address] area OR104 of the object O20 is a character string for an e-mail address, the controller 11 displays the character string (“James.Oliver_test_mail”) included in the front portion of the e-mail address (a part preceding @) in the tooltip 20.

As described above, according to the fourth embodiment, in addition to the effects of the first embodiment, it is possible to change a display start position of a character string depending on a type of a caption displayed in an object, as a result of which it possible to display a tooltip where a display of a character string not highly necessary is eliminated as a display item.

### 5 Fifth Embodiment

In a fifth embodiment, the display form of the tooltip 20 is changed according to a user operation on an object. In the fifth embodiment, if a time during which a user operates on an object (a time during which an object is pointed to) exceeds a predetermined time, the size of the display area of the tooltip 20 or the font size of the character string is increased/reduced.

The functional configuration of the image forming apparatus 100 incorporating the display device 103 according to the fifth embodiment can be similar to that according to the first embodiment, and therefore description thereof will be omitted here.

### 5.1 Process Flow

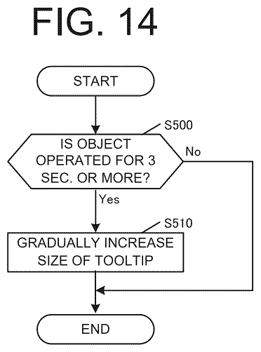

A process flow of the fifth embodiment will be described. FIG. 14 is a flowchart illustrating a process for increasing the display area of the tooltip 20 or the font size of a character string if a time during which a user operates on an object (a time during which an object is pointed to) exceeds a predetermined time. The process described with reference to FIG. 14 is executed by the controller 11 reading out the display control program 193, the operation position determination program 195, and the like.

The controller 11 determines whether a time during which the user operates on the object (a time during which an object is pointed to) continues for three seconds or more (step S500).

If the controller 11 determines that a time during which the user operates on the object (a time during which the object is pointed to) continues for three seconds or more, the controller 11 gradually increases at least one of the display size of the display area of the tooltip 20 and the font size of the character string, and the process ends (step S500; if Yes, the process proceeds to step S510, and the process proceeds to “End”). On the other hand, if the controller 11 determines that a time during which the user operates on the object (a time during which the object is pointed to) is less than three seconds, the process ends (step S500; if No, the process proceeds to “End”). It is noted that in FIG. 14, a time during which the user continuously operates on the object is described as three seconds (or more); however, the continuous operation time is not limited to three seconds and may be five seconds, ten seconds, and the like, and there is no limit to the operation time as long as the controller 11 can sense the continuous user operation.

### 5.2 Example of Operation

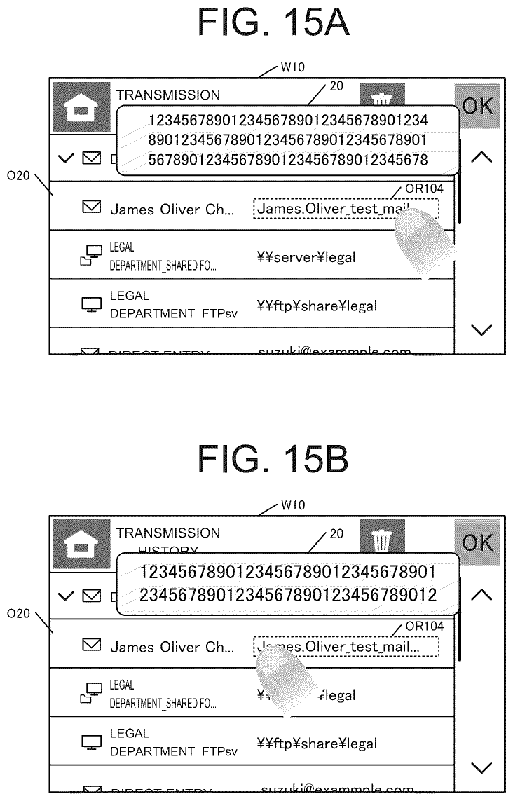

FIG. 15A illustrates an example of a display configuration in a case where a display size of a display area of the tooltip 20 is increased when a user continuously operates (points out) the[Address] area OR104 of the object O20 (“James.Oliver_test_mail . . . ”). In FIG. 15A, for ease of understanding, the character strings displayed in the tooltip 20 are expressed in half-width numeric characters.

When the[Address] area OR104 of the object O20 is operated by the user for a predetermined time or more, the controller 11 gradually increases the display size of the display area of the tooltip 20. FIG. 15A illustrates an example in which the display size of the display area of the tooltip 20 is increased to a display size in which character strings for three lines, each line of which contains 34 half-width numeric characters (corresponding to the display size of the tooltip 20c or 20f in FIG. 4C) can be displayed according to a user operation for a predetermined time or more. It is noted that although FIG. 15A illustrates an example in which the display size of the display area of the tooltip 20 is gradually increased if the user operates the area for a predetermined time or more, the display size of the display area of the tooltip 20 may be gradually reduced depending on a time during which the user operates the area.

FIG. 15B illustrates an example of a display configuration in a case where the font size of a character string in the tooltip 20 is increased if a user operates (points out) the[Address] area OR104 of the object O20 (“James.Oliver_test_mail . . . ”) for three seconds and more. In FIG. 15B, for ease of understanding, the character string displayed in the tooltip 20 is expressed in half-width numeric characters.

When the[Address] area OR104 of the object O20 is operated by the user for a predetermined time or more, the controller 11 gradually increases the font size of the character string in the tooltip 20. FIG. 15B illustrates an example in which the font size of the character string in the tooltip 20 is increased, for example, from 12 pt to 14 pt according to a user operation (time). It is noted that although FIG. 15B illustrates an example in which the font size of the character string in the tooltip 20 is gradually increased if the user operates the area for a predetermined time or more, the font size of the character string in the tooltip 20 may be gradually reduced according to a time during which the user operates the area. The display size of the display area illustrated in FIG. 15A and the font size of the character string illustrated in FIG. 15B may both be increased/reduced by a user operation for a predetermined time or more.

As described above, according to the fifth embodiment, if a time during which a user operates on an object (a time during which an object is pointed to) exceeds a predetermined time, it is possible to either increase/reduce the size of a display area of a tooltip or increase/reduce the font size of the character string, as a result of which it is possible to further improve a visibility and a readability of the tooltip that the user wishes to display.

### 6 Sixth Embodiment

A sixth embodiment is another aspect in which the display form of the tooltip 20 is changed according to a user operation on an object. In the sixth embodiment, the size of the display area of the tooltip 20 is changed according to a user operation on the tooltip 20.

The functional configuration of the image forming apparatus 100 incorporating the display device 103 according to the sixth embodiment can be similar to that according to the first embodiment, and therefore description thereof will be omitted here.

### 6.1 Process Flow

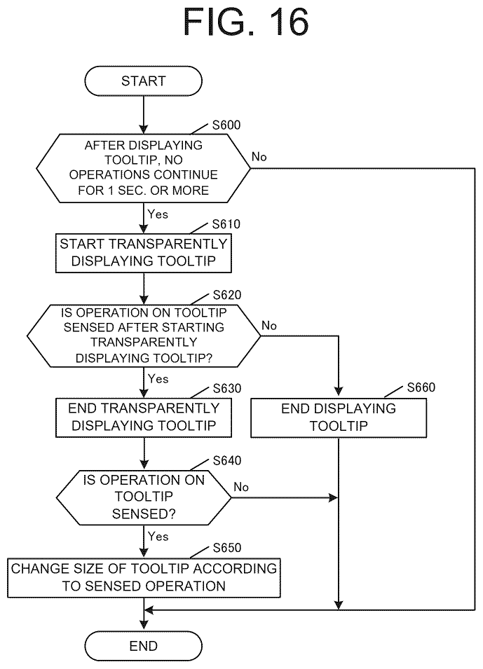

A process flow of the sixth embodiment will be described. FIG. 16 is a flowchart illustrating a process for changing the size of the display area of the tooltip 20 according to a user operation on the tooltip 20 displayed on the operation screen. The process described with reference to FIG. 16 is executed by the controller 11 reading out the display control program 193, the operation position determination program 195, and the like.

The controller 11 determines whether there is no user operations for, for example, one second or more after the tooltip 20 is displayed (step S600). If the controller 11 determines that there is no user operations for one second or more, the controller 11 starts transparently displaying the tooltip 20 (step S600; if Yes, the process proceeds to step S610). If the controller 11 determines that there is no user operations for one second or more, the process ends (step S600; if No, the process proceeds to “End”).

Next, the controller 11 determines whether a user operation (for example, a touch operation) on the tooltip 20 after starting transparently displaying the tooltip 20 is sensed (step S620). If the controller 11 determines that a user operation on the tooltip 20 after starting transparently displaying the tooltip 20 is sensed, the controller 11 ends transparently displaying the tooltip 20 (step S620; if Yes, the process proceeds to step S630).

Then, the controller 11 determines whether a user operation (for example, a drag operation) on the tooltip 20 is sensed (step S640). If the controller 11 determines that a user operation on the tooltip 20 is sensed, the controller 11 changes the size of the display area of the tooltip 20 to match the sensing operation (a drag operation range) and the process ends (step S640; if Yes, the process proceeds to step S650, and the process proceeds to “End”).

However, if the controller 11 determines that no user operations, such as a touch operation, on the tooltip 20 are sensed after starting transparently displaying the tooltip 20, the controller 11 ends displaying the tooltip 20 and the process ends (step S620; if No, the process proceeds to step S660, and the process proceeds to “End”). Moreover, if the controller 11 determines that a user operation such as a drag operation on the tooltip 20 is not sensed, the process ends (step S640; if No, the process proceeds to “End”).

### 6.2 Example of Operation

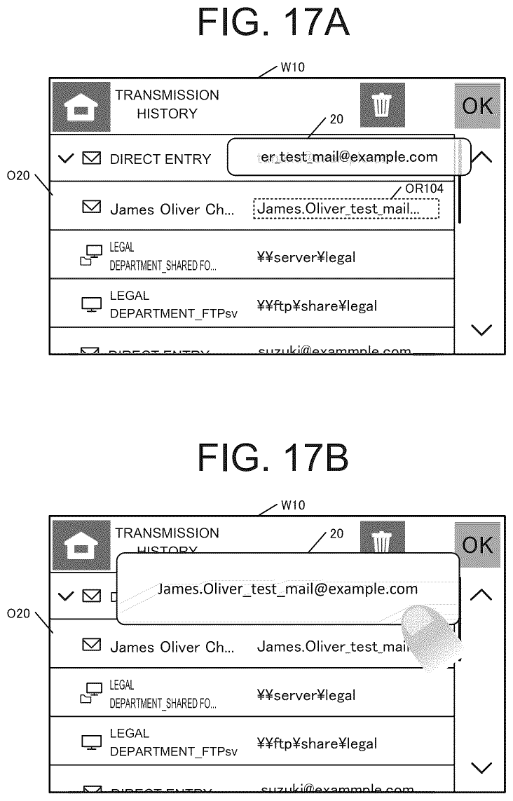

FIG. 17A illustrates an example of a display configuration of the tooltip 20 transparently displayed by the controller 11 if the controller 11 determines that there are no user operations for one second or more after the tooltip 20 corresponding to the[Address] area OR104 of the object O20 (“James.Oliver_test_mail . . . ”) is displayed. The tooltip 20 illustrated in FIG. 17A is a tooltip in which the rear half portion of the display item representing the[Address] (“er_test_mail@example.com”), which is illustrated in FIG. 11A of the third embodiment is displayed.

FIG. 17B illustrates an example of a display configuration of the tooltip 20 displayed by the controller 11 if a user operation such as a drag operation is sensed in the tooltip 20 transparently displayed in FIG. 17A. FIG. 17B illustrates an example in which the display size of the display area of the tooltip 20 is increased in response to a user operation such as a drag operation to a display size (corresponding to the display size of the tooltip 20c in FIG. 4C) in which character strings for three lines, each line of which contains 34 half-width numeric characters can be displayed.

As described above, according to the sixth embodiment, it is possible to change the size of a display area of a tooltip in response to a user operation on the tooltip displayed on an operation screen, and thus, similar to the fifth embodiment, it is possible to further improve a visibility and a readability of the tooltip that the user wishes to display.

### 7 Seventh Embodiment

A seventh embodiment is an aspect in which at least one of a change in display size of a display area of the tooltip 20 and a change in font size of a character string is applied as a default setting in accordance with a user authenticated by user authentication.

For example, for a user who wishes to increase a readability of a character string in the tooltip 20 by increasing the font size of the character string, the process for increasing the font size of the character string described in the fifth embodiment is enabled in a default setting.

On the other hand, for a user who does not wish to increase the font size of the character string in the tooltip 20 but wishes to display the entire display area of the tooltip 20, the scrolling display of the character string according to the second embodiment and the process for increasing the display size of the display area of the tooltip 20 according to the sixth embodiment are enabled in a default setting.

As described above, according to the seventh embodiment, depending on a user authenticated by user authentication, it is possible to apply at least one of a change in display size of the display area of a tooltip and a changes in font size of a character string in a default setting, as a result of which it is possible to realize a highly convenient operation for each user.

The present disclosure is not limited to the above-described embodiments, and various modifications are possible. In other words, embodiments obtained by combining technical means appropriately modified within the scope not deviating from the gist of the present disclosure are also included in the technical scope of the present disclosure.

Although the above-described embodiments are described separately for convenience of explanation, it goes without saying that the embodiments may be combined and executed within a technically feasible range.

A program running on each device in the embodiments is a program that controls a CPU and the like (a program that causes a computer to function) to realize the above-described functions of the embodiments. The information handled in the device is temporarily accumulated in a temporary storage device (for example, a RAM) during processing, and is then stored in various types of storage devices such as a read only memory (ROM) and a hard disk drive (HDD), and is read, modified, and written by the CPU, as necessary.

Here, a computer-readable non-transitory recording medium on which a program in an information processing device is recorded may be any of a semiconductor medium (for example, a ROM and a non-volatile memory card), an optical recording medium/magneto-optical recording medium (for example, a digital versatile disc (DVD), a magneto optical disc (MO), a mini disc (MD), a compact disc (CD), and a Blu-ray (registered trademark) disc (BD)), a magnetic recording medium (for example, a magnetic tape and a flexible disk), and the like. In such a case, the program recorded on the recording medium is read by the computer of the information processing device and executed by the computer, as a result of which it is possible to realize the functions of the above-mentioned embodiments, and also to realize the functions of the present disclosure by performing processing in cooperation with an operating system, other application programs, or the like, based on the instructions of the program.

In distributing a program on a market, the program can be stored on a portable recording medium and distributed, or transferred to a server computer connected via a network such as the Internet. In such a case, it goes without saying that the storage device of the server computer is also included in the present disclosure.

Each functional block or feature of the device used in the above-described embodiment can be implemented and executed by an electric circuit, for example, an integrated circuit or a plurality of integrated circuits. An electric circuit designed to realize the functions described herein may include a general purpose processor, a digital signal processor (DSP), an application specific integrated circuit (ASIC), a field programmable gate array (FPGA) or another programmable logic device, a discrete gate or a transistor logic, a discrete hardware component, or any combination thereof. The general purpose processor may be a microprocessor, or any known processor, controller, microcontroller, or state machine. The above-mentioned electric circuit may include a digital circuit or an analog circuit. If an integrated circuit technology replacing current integrated circuits emerges due to advances in semiconductor technology, one or more aspects of the present disclosure may also use a new integrated circuit based on that technology.

What is claimed is:

1. A display device comprising:
a display that displays an operation screen including an object; and
a controller that controls display of an additional display corresponding to the object, based on a user operation on the object, wherein
the controller changes a display mode of the additional display in accordance with a positional relationship between an arrangement position of the object on the operation screen and a position of the user operation on the object.

2. The display device according to claim 1, wherein
the controller changes a display item displayed in the additional display as the display mode.

3. The display device according to claim 1, wherein
the controller changes a display size of a display area of the additional display as the display mode.

4. The display device according to claim 1, wherein
for a display item exceeding a display size of a display area of the additional display, the controller changes a display form of a character string included in the display item.

5. The display device according to claim 4, wherein
the controller scroll-displays the character string.

6. The display device according to claim 4, wherein
the controller changes a display position of the character string.

7. The display device according to claim 4, wherein
the controller changes a display start position of the character string depending on a type of a caption displayed in the object.

8. The display device according to claim 1, wherein
the controller changes at least one of a display area of the additional display and a display size of a character string included in a display item according to continuation of the user operation on the object.

9. The display device according to claim 1, wherein
the additional display includes a tooltip.

10. The display device according to claim 1, wherein
the operation screen includes a system area and a selection area for scroll-displaying selectable items, and the number of the selectable items is five or less.

11. An image forming apparatus comprising:
a display that displays an operation screen including an object;
a controller that controls display of an additional display corresponding to the object, based on a user operation on the object; and
an image processing operator, wherein
the controller changes a display mode of the additional display in accordance with a positional relationship between an arrangement position of the object on the operation screen and a position of the user operation on the object.

12. A display control method for an additional display comprising:
displaying an operation screen including an object;
controlling display of an additional display corresponding to the object, based on a user operation on the object; and
changing a display mode of the additional display in accordance with a positional relationship between an arrangement position of the object on the operation screen and a position of the user operation on the object.
